(19) United States
(12) Patent Application Publication
(10) Pub. No.: US 2010/0235240 A1
(43) Pub. Date: Sep. 16, 2010

(54) AUTOMATIC VENDING APPARATUS FOR PROVIDING ADVERTISEMENT AND METHOD THEREOF

(75) Inventors: Yeon-jun PARK, Seoul (KR); Young-ho KIM, Suwon-si (KR); Sung-gi KIM, Suwon-si (KR); Young-gyoo PARK, Incheon (KR); Haeng-chul LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/648,679

(22) Filed: Dec. 29, 2009

(30) Foreign Application Priority Data
Mar. 16, 2009 (KR) 10-2009-0022204

(51) Int. Cl. G06Q 30/00; G06F 17/00

(52) U.S. Cl. 705/14.61; 700/232; 700/236

(57) ABSTRACT

An automatic vending apparatus and an advertisement method thereof are provided. The automatic vending apparatus receives advertisement content and an advertisement schedule through a network, stores the received information, and replays the stored advertisement content on a touch screen in accordance with the stored advertisement schedule. Since it is possible to provide advertisement through automatic vending apparatuses according to a predetermined, advertisement can be provided in a more systematic, various and efficient manner.

### CROSS-REFERENCE TO RELATED APPLICATION

This application claims priority from Korean Patent Application No. 10-2009-0022204, filed on Mar. 16, 2009, in the Korean Intellectual Property Office, the disclosure of which is incorporated herein by reference in its entirety.

### BACKGROUND

1. Field

Apparatuses and methods consistent with exemplary embodiments of the present invention relate to an automatic vending apparatus, and more particularly, to an automatic vending apparatus capable of vending goods in stock automatically.

2. Description of the Related Art

Use of automatic vending apparatuses has almost exploded due to advantages such as convenience of operation, unlimited operation time and reduced labor cost.

Originally, automatic vending apparatuses have vended a limited number of tangible goods such as soft drinks or disposable tissues. However, a wider range of goods—even including intangible goods such as digital sound source, or the like—is now being sold by the vending apparatuses. As a result, more and more vending apparatuses are expected to be installed and made available.

Considering such a dramatically increasing number of automatic vending apparatuses, it will be quite inefficient to limit the use of vending apparatuses to the sales of goods. Therefore, a new approach is necessary, which makes it possible to use an automatic vending apparatus for a variety of purposes. Furthermore, a new concept of vending machine, which provides customers with a variety of useful things as well as goods, is required.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide an automatic vending apparatus which is usable for a variety of purposes.

Exemplary embodiments of the present invention also provide an automatic vending apparatus capable of providing advertisements in accordance with a predetermined schedule, and a method thereof for providing an advertisement.

Consistent with an aspect of the present invention, an automatic vending apparatus, includes a touch screen which displays a graphic user interface (GUI) for sales of goods, a vending unit which provides goods if the goods is ordered through the GUI for sales of goods and a payment for the ordered goods is received, a communication interface which receives advertisement content and an advertisement schedule through a connected network, a storage unit which stores the received advertisement content and the advertisement schedule, and a control unit which replays the advertisement content stored in the storage unit on the touch screen in accordance with the advertisement schedule stored in the storage unit.

The control unit may delete at least one of the advertisement schedule and the advertisement content from the storage unit, if the replay of the advertisement content according to the advertisement schedule is finished. Hereinafter, “at least one of” as used in a context such as “at least one of A and B” means (A), (B), or (A and B).

The control unit may replay advertisement content about another goods related to the ordered goods on the touch screen, during the time when the vending unit provides the ordered goods.

The advertisement schedule may include at least one of place, date, content, manner, and cost of advertisement.

The storage unit may additionally store content, and the control unit downloads the stored content of the storage unit to a user's device through the communication interface.

The control unit may delete the content from the storage unit if a predetermined period elapses.

The automatic vending apparatus may further include a photographing unit which photographs an image in front of the automatic vending apparatus, and the control unit transmits the content photographed by the photographing unit to a route designated by a user through the communication interface.

The control unit may control so that a game is provided on the touch screen and goods is provided free-of-charge through the vending unit according to a result of the game.

The control unit may notify a manager through the communication interface if the automatic vending apparatus has at least one of destruction, malfunction, and problem about stock.

The control unit may display information received through the communication interface on the touch screen, in which the information comprises a really simple syndicate (RSS), a broadcast, and an emergency notice.

The control unit may store information about sales amount and customers to the storage unit, and notify the stored information to the manager through the communication interface.

Consistent with another aspect of the present invention, a method for providing an advertisement in an automatic vending apparatus which provides goods if the goods is ordered and paid, includes receiving advertisement content and an advertisement schedule through a connected network, storing the received advertisement content and the advertisement schedule, and replaying the stored advertisement content in accordance with the stored advertisement schedule.

The method may further include deleting the advertisement schedule and the advertisement content from the storage unit, if the replaying of the advertisement content according to the advertisement schedule is finished.

The method may further include replaying advertisement content about another goods related to the ordered goods, during the time when the ordered goods is being provided.

The advertisement schedule may include at least one of place, date, content, manner, and cost of advertisement.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a perspective view of an automatic vending apparatus according to an exemplary embodiment of the present invention;

FIG. 2 is a block diagram of the automatic vending apparatus of FIG. 1;

FIG. 3 is a flowchart illustrating a process of automatic vending function;

FIG. 4 illustrates the result of executing S310 of FIG. 3;

FIG. 5 illustrates the result of executing S330 of FIG. 3;

FIG. 6 is a flowchart illustrating a process of performing content downloading;

FIG. 7 illustrates the automatic vending apparatus which displays the GUI for content selection on the touch screen;

FIG. 8 is a flowchart illustrating a process of performing the UCC function;

FIG. 9 illustrates the automatic vending apparatus in which the GUI for UCC type selection is provided on the touch screen;

FIG. 10 illustrates the result of operation at S830 of FIG. 8, if the customer selects photograph-UCC at S820 of FIG. 8;

FIG. 11 illustrates the automatic vending apparatus in which the touch screen displays the GUI for selecting method of providing UCC as a result of operation at S850 of FIG. 8;

FIG. 12 illustrates an example where the e-mail transmission is selected as a method of receiving UCC, in which a GUI to input an e-mail address as the path to receive UCC is presented;

FIG. 13 illustrates an example where the blog uploading is selected as a method of receiving UCC, in which a GUI to input blog address and other necessary information including ID and password (P/W) is presented;

FIG. 14 is a flowchart illustrating the process of function of providing games;

FIG. 15 illustrates the automatic vending apparatus 100 in which the GUI for game mode selection is displayed on the touch screen 120.

FIG. 16 illustrates the automatic vending apparatus in which a slot machine game on the single game mode is provided on the touch screen 120;

FIG. 17 illustrates the automatic vending apparatus which displays the message on the touch screen, indicating that the player has won the prize, and subsequently provides a soft drink through the goods release unit as the prize;

FIG. 18 illustrates the automatic vending apparatus in the middle of executing S1455 of FIG. 14;

FIG. 19 illustrates the automatic vending apparatus in which a multi game is provided on the touch screen;

FIG. 20 illustrates an example in which the second player (2P) wins the multi game;

FIG. 21 illustrates the winner inputting his mobile device number using the GUI for inputting device number, and a mobile coupon received at the winner's mobile device as a result;

FIG. 22 is a flowchart illustrating the process of protection function;

FIG. 23 illustrates someone striking the automatic vending apparatus;

FIG. 24 illustrates the photograph taken at S2230 of FIG. 22 and explanation of current status spearing on the touch screen;

FIG. 25 illustrates a network applicable according to an exemplary embodiment of the present invention;

FIG. 26 illustrates a series of operations taken to provide a reserved advertisement according to schedule;

FIG. 27 illustrates an example of the advertisement schedule timetable;

FIG. 28 illustrates a plurality of automatic vending apparatuses performing ‘multi screen’ advertisement;

FIG. 29 illustrates the automatic vending apparatus providing really simple syndicate (RSS) of the local weather on the touch screen; and

FIG. 30 illustrates the automatic vending apparatus providing a sports broadcast on the touch screen.

### DETAILED DESCRIPTION OF THE EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

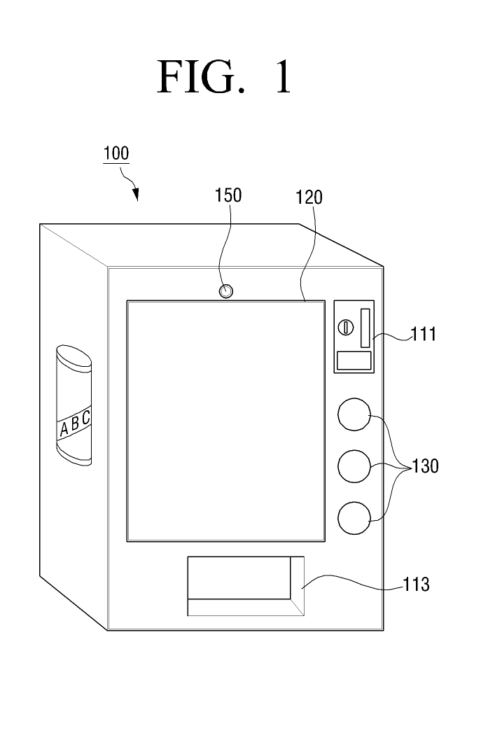

FIG. 1 is a perspective view of an automatic vending apparatus according to an exemplary embodiment of the present invention. Referring to FIG. 1, an automatic vending apparatus 100 according to an exemplary embodiment of the present invention includes a photographing unit 150 formed on a front side, a touch screen 120, a payment receiving unit 111, an operating unit 130, and a goods release unit 113.

The touch screen 120 is a display which not only provides a customer with visual information and graphical user interface (GUI), but also receives a command and selection that user inputs.

The operating unit 130 includes a plurality of physical operating buttons which are used by a customer to input his command.

The photographing unit 150 captures images in front of the automatic vending apparatus 100. Although FIG. 1 depicts that the body of the photographing unit 150 is housed inside the automatic vending apparatus 100, this is only for the illustrative purpose, and other examples are possible. Accordingly, by way of example, the body of the photographing unit 150 may be provided on the upper outer side of the automatic vending apparatus 100.

The payment receiving unit 111 is provided to receive coins, bills, credit cards, or the like, which are paid by a customer for the purchased goods. The goods release unit 113 is the place where a customer accesses to get the purchased goods.

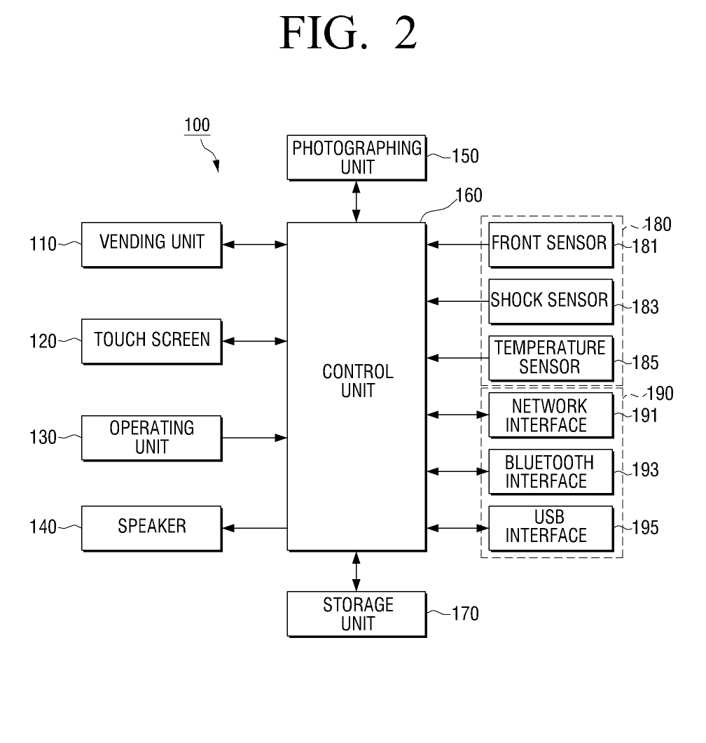

FIG. 2 is a block diagram of the automatic vending apparatus 100 of FIG. 1. Referring to FIG. 2, the automatic vending apparatus 100 may include a vending unit 110, a touch screen 120, an operating unit 130, a speaker 140, a photographing unit 150, a control unit 160, a storage unit 170, a sensor 180, and a communicating unit 190.

The vending unit 110 performs a series of processing to vend the goods kept in stock in the automatic vending apparatus 100 to a customer automatically. To this purpose, the vending unit 110 receives payment for the goods selected by the user through the payment receiving unit 111, and provides the paid goods to the goods release unit 113.

Since the touch screen 120, the operating unit 130 and the photographing unit 150 are similar to those explained above with reference to FIG. 1, detailed description thereof will be omitted. The speaker 140 provides a customer with audio information.

The storage unit 170 provides the space to store information necessary to operate the automatic vending apparatus 100. The ‘information’ may include content, a game program, advertisement content and an advertisement schedule timetable. Although it may be preferred to employ a storage device of large capacity such as hard disk drive (HDD), considering that the storage unit 170 generally stores a relatively large amount of information, this should not be construed as limiting. Therefore, other types of storage media may also be employed.

The sensor 180 detects condition necessary to operate and protect the automatic vending apparatus 100, and may include a front sensor 181, a shock sensor 183, and a temperature sensor 185.

The front sensor 181 detects to determine whether there is a customer moving toward the front of the automatic vending apparatus 100. The shock sensor 183 detects to determine whether the automatic vending apparatus 100 is hit and has the possibility of malfunction or breakage. The temperature sensor 185 detects internal temperature of the automatic vending apparatus 100.

The communicating unit 190 provides a communication interface, enabling the automatic vending apparatus 100 to communicate with external devices, and may include a network interface 191, a Bluetooth interface 193, and a universal serial bus (USB) interface 195.

The network interface 191 connects the automatic vending apparatus 100 to the external servers so that the automatic vending apparatus 100 can communicate with the external servers via backbone networks such as the internet or local area network (LAN). The Bluetooth interface 193 enables the automatic vending apparatus 100 to communicate with a customer's Bluetooth device in a Bluetooth communication manner. Finally, the USB interface 195 connects so that the automatic vending apparatus 100 can communicate with a USB device in a USB communication manner.

The control unit 160 controls the elements of the automatic vending apparatus 100 mainly illustrated in FIG. 2 so that the automatic vending apparatus 100 can perform functions of providing: goods by automatic vending; contents; games; protection; notices; advertisements; information; and marketing management. The operation of the control unit 160 to perform the abovementioned functions will be explained below function by function in greater detail.

### Automatic Vending

The function of automatic vending is the basic function of the automatic vending apparatus 100, and mainly includes vending of goods kept in stock in the automatic vending apparatus 100 to a customer automatically.

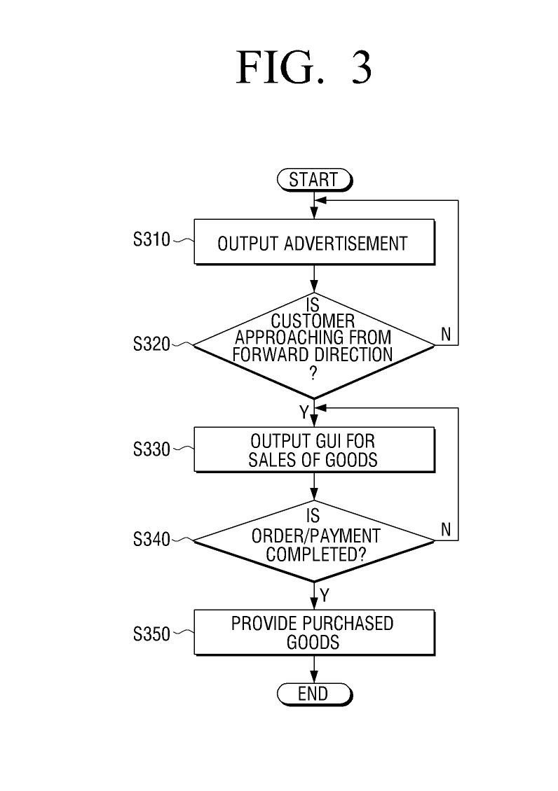

FIG. 3 is a flowchart illustrating a process of automatic vending function. Referring to FIG. 3, at S310, the control unit 160 outputs advertisement content stored in the storage unit 170 through the touch screen 120 and the speaker 140.

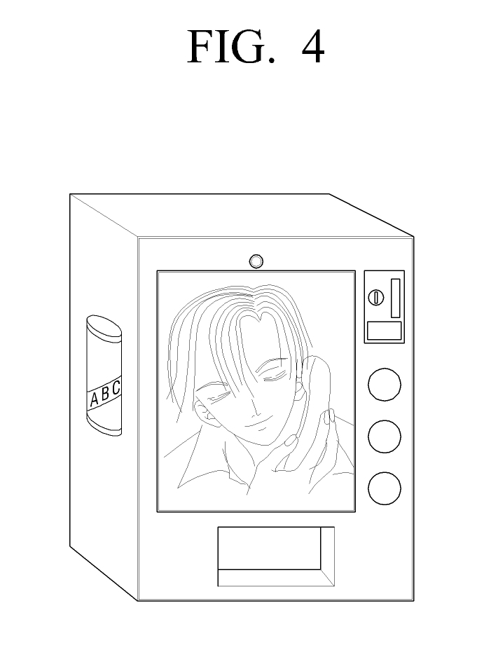

FIG. 4 illustrates the result of executing S310. Referring to FIG. 4, the automatic vending apparatus 100 outputs the advertisement content through the touch screen 120 provided in the front side, as a result of operation at S310.

At S320-Y, if the front sensor 181 detects that a customer is moving to the front of the automatic vending apparatus 100 in the middle of operation at S310, the control unit 160 outputs a GUI for sales of goods through the touch screen 120 at S330.

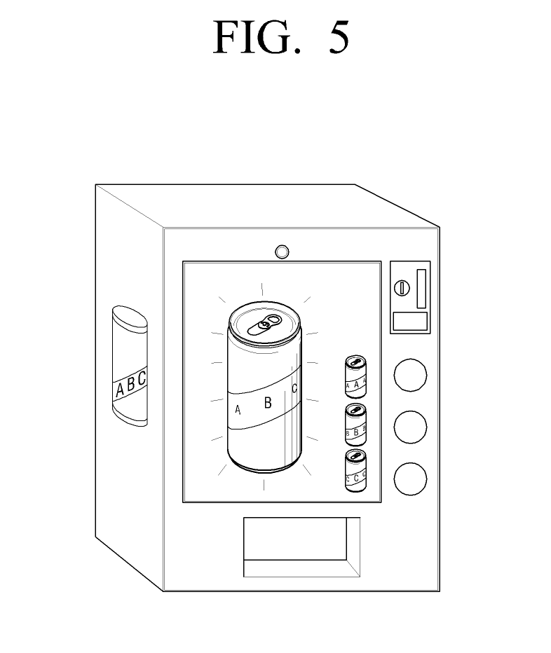

FIG. 5 illustrates the result of executing S330. Referring to FIG. 5, the automatic vending apparatus 100 outputs the GUI for sales of goods through the touch screen 120 provided in the front side, as a result of operation at S330.

Meanwhile, the control unit 160 may output audio information through the speaker 140, in addition to the GUI for sales of goods displayed on the touch screen 120, to draw the customer's attention more effectively.

At S340-Y, if the customer completes making his order using the GUI for sales of goods outputted on the touch screen 120 and/or the operating buttons provided on the operating unit 130, and inputs payment through the payment receiving unit 111, the control unit 160 controls the vending unit 110 to provide the ordered goods through the goods release unit 113, at S350.

### Content

The function of providing content may include a content downloading and providing of a user created content (UCC), which will be explained in detail below.

### Content Downloading

The ‘content downloading’ refers to downloading of the content stored in the storage unit 170 of the automatic vending apparatus 100 to a user's mobile device automatically.

The content downloading may be performed as a supplementary function, generally after the sale of goods. However, this is only for an illustrative example and other examples are possible. By way of example, the content may be downloaded as a prize offered in a specific event or as redemption to a mobile coupon.

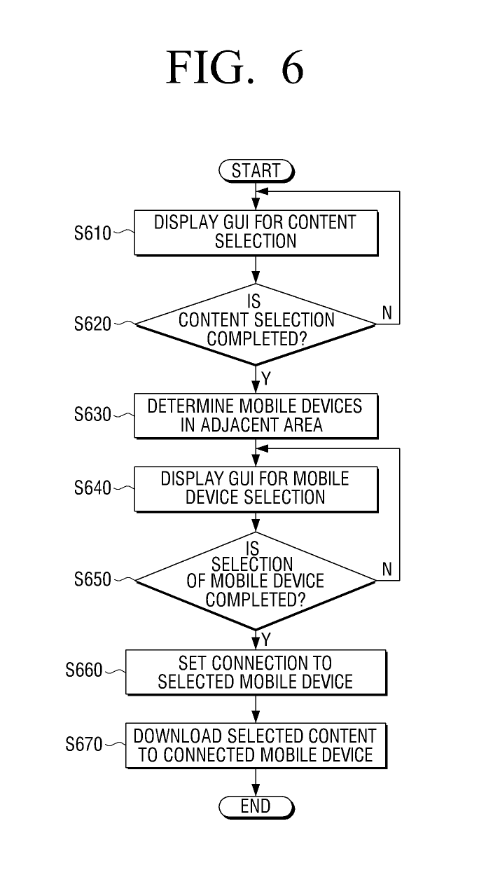

FIG. 6 is a flowchart illustrating a process of performing content downloading. Referring to FIG. 6, at S610, the control unit 160 provides a customer with a GUI for content selection by displaying it on the touch screen 120.

The term ‘GUI for content selection’ is a GUI which has a list of the contents under predetermined categories downloadable to a customer's mobile device. Accordingly, the customer can select a desired content using the GUI.

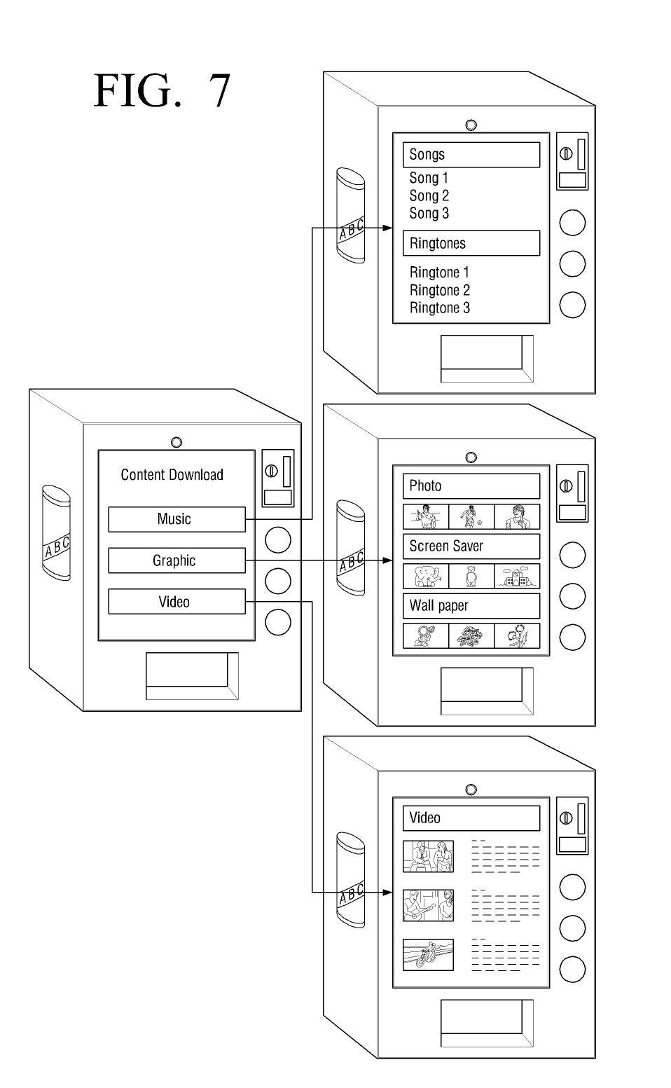

FIG. 7 illustrates the automatic vending apparatus 100 which displays the GUI for content selection on the touch screen 120. Referring to FIG. 7, the contents on the GUI are grouped and displayed under respective categories.

By way of example, if a customer selects ‘Music’ item on the initial screen of the GUI, corresponding contents including song content and ring tone content are displayed. Likewise, photo content, screen saver content, wallpaper content, or the like may be displayed in response to a selection of a ‘Graphic’ item, and a video content may be displayed in response to a selection of a ‘Video’ item.

At S620-Y, if the customer completes selecting desired content using the GUI, the control unit 160 scans through the Bluetooth interface 193 and finds out the mobile devices located adjacent to the automatic vending apparatus 100, at S630.

At S640, the control unit 160 displays for the customer a GUI for mobile device selection on the touch screen 120 based on the result of determination of S630. The term ‘GUI for mobile device selection’ is a GUI which presents a list of mobile devices found out to be adjacent to the automatic vending apparatus 100 at S630. The customer may select his mobile device and input PIN number through this GUI.

At S650-Y, if the customer completes selecting his mobile device and inputting a PIN number using the GUI for mobile device selection, the control unit 160 controls the Bluetooth interface 193 to set a connection to the customer's mobile device selected at S650, at S660.

If the setting for connecting communication is completed, the control unit 160 controls so that the content selected at S620 is downloaded from the storage unit 170 to the user's mobile device via the Bluetooth interface 193, at S670.

Although it has been described above that the contents are grouped under the category of content form in the initial state of GUI for content selection, other examples are also possible. Accordingly, the contents may be categorized according to various other references such as genre, artists, albums, amounts, dates of making, or the like.

Meanwhile, in order to ensure sufficient space in the storage unit 170, the control unit 160 may automatically delete the expired contents from the storage unit 170.

### User Created Content (UCC)

UCC function supports a customer to create his own UCC, and provides the customer with the completed UCC so that the customer can keep this UCC.

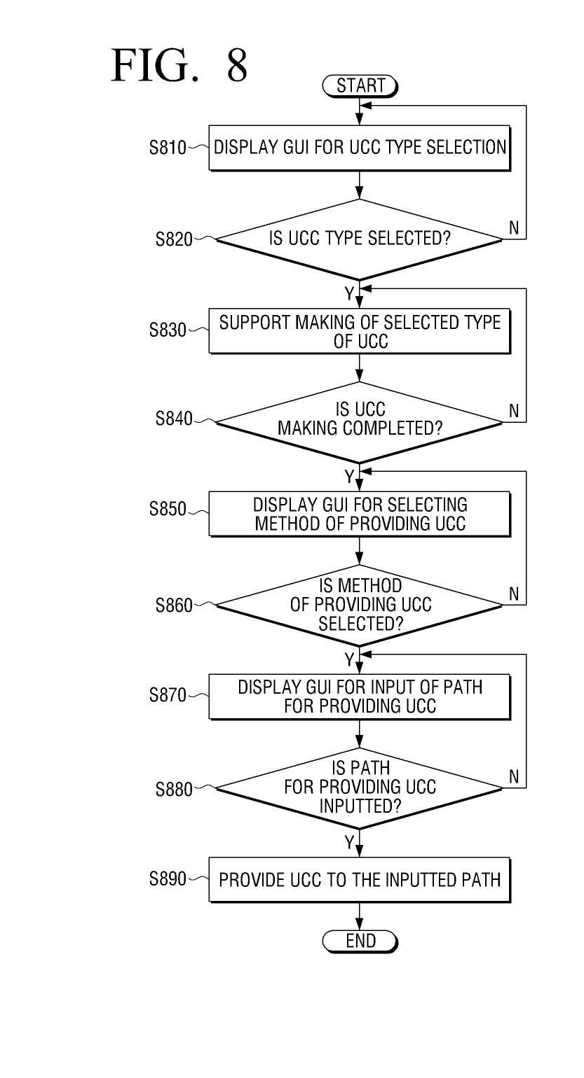

FIG. 8 is a flowchart illustrating a process of performing the UCC function. Referring to FIG. 8, the control unit 160 may present the customer with a GUI for UCC type selection by displaying the GUI on the touch screen 120, at S810.

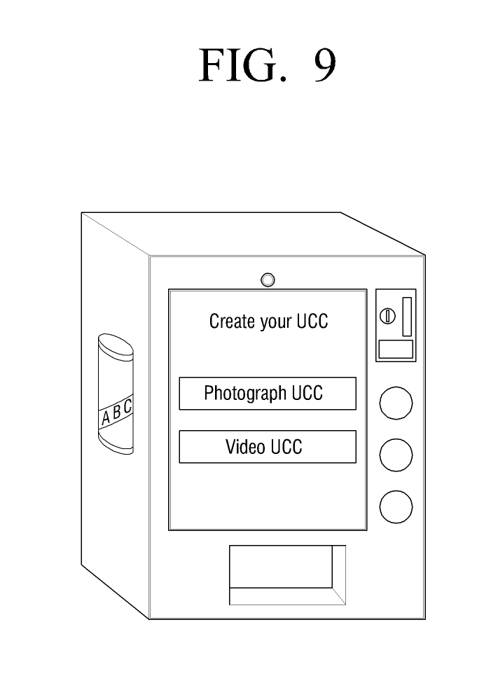

FIG. 9 illustrates the automatic vending apparatus 100 in which the GUI for UCC type selection is provided on the touch screen 120 as a result of operation at S810. The GUI for UCC type selection exemplified in FIG. 9 particularly enables the customer to choose between a photograph UCC and a video UCC.

At S820-Y, if the UCC type is selected through the GUI for UCC type selection, the control unit 160 controls the photographing unit 150 and the touch screen 120 so that the selected type of UCC can be made, at S830.

In detail, at S830, the control unit 160 controls the photographing unit 150 to take photographs or video of the customer who is in front of the automatic vending apparatus 100, controls the touch screen 120 to display the result of photographing at the photographing unit 150, and additionally provides guide information necessary for the photographing on the touch screen 120.

Whether the photographing unit 150 takes photographs of the customer or the video depends on the user selection of S820. Accordingly, if the customer selects photograph UCC at S820, the control unit 160 controls the photographing unit 150 to take photographs of the customer. However, if the customer selects video UCC at S820, the control unit 160 controls the photographing unit 150 to take video of the customer.

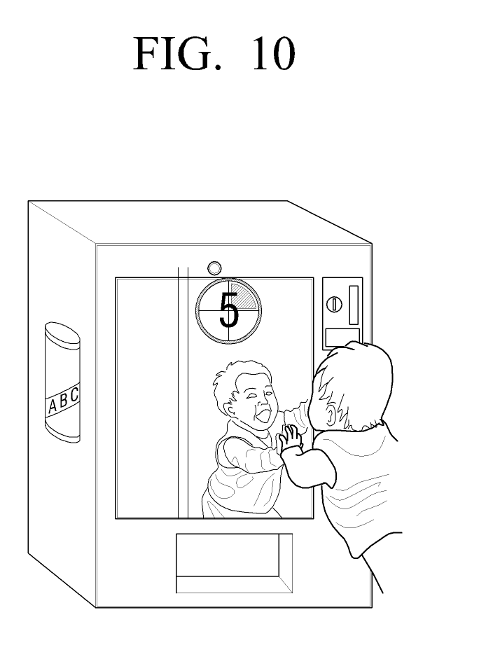

FIG. 10 illustrates the result of operation at S830, if the customer selects photograph UCC at S820. Referring to FIG. 10, the touch screen 120 presents the image as a result of photographing by the photographing unit 150, and additionally provides the guide information indicating that the photographing is going to be taken place after 5 seconds.

At S840-Y, if the making of the UCC is completed, the control unit 160 presents the customer with a GUI for selecting a method of providing UCC, by displaying the GUI on the touch screen 120, at S850.

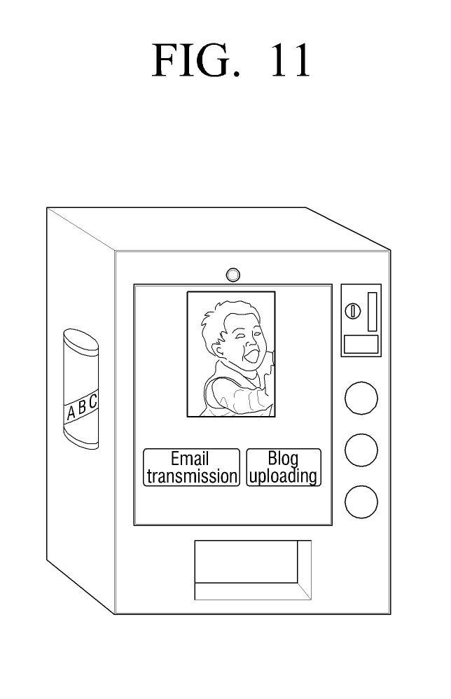

FIG. 11 illustrates the automatic vending apparatus 100 in which the touch screen 120 displays the GUI for selecting a method of providing UCC as a result of operation at S850.

Referring to FIG. 11, the GUI for selecting a method of providing UCC displays the completed UCC on its upper portion, and also indicates that the UCC can be provided by e-mail and blog uploading, i.e., uploading onto a blog. Accordingly, the customer may view the completed UCC through the provided GUI, and also select the method with which he wishes to receive the completed UCC.

At S860-Y, if the customer selects the method of providing UCC, the control unit 160 presents the customer with a GUI for an input of path for providing UCC, by displaying the GUI on the touch screen 120, at S870. Accordingly, the customer may input a path to receive the UCC of S860 and other necessary information through the GUI.

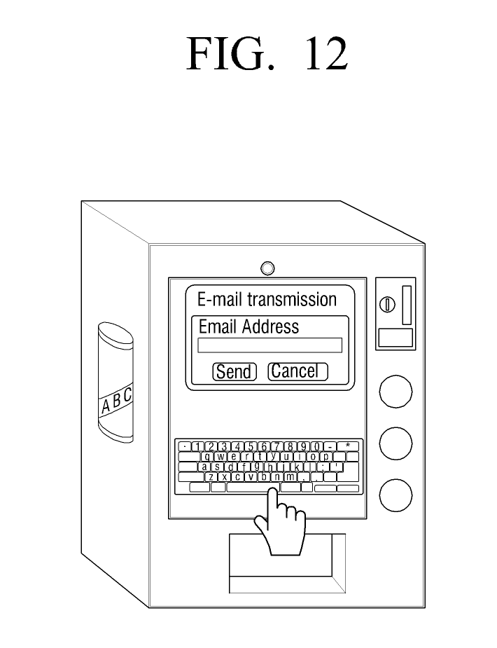

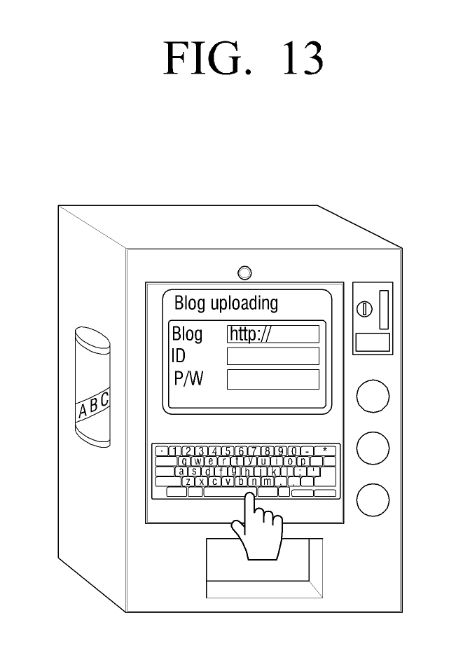

FIG. 12 illustrates an example where the e-mail transmission is selected as a method of receiving UCC, in which a GUI to input an e-mail address as the path to receive UCC is presented, and FIG. 13 illustrates an example where the blog uploading is selected as a method of receiving UCC, in which a GUI to input blog address and other necessary information including ID and password (P/W) is presented.

At S880-Y, if the path to receive UCC is completely inputted through the GUI provided at S870, the control unit 160 provides the UCC through the inputted path so that the customer can keep the UCC, at S890.

Although it has been exemplified above that the content and UCC are downloaded or provided free-of-charge, this is only one of examples. Therefore, the content or UCC may be provided upon payment.

Furthermore, although the automatic vending apparatus 100 is described as being connected to the user's mobile device in a Bluetooth manner, this is only one of examples. Therefore, the automatic vending apparatus 100 may be connected in various wireless communication manners.

Additionally, the automatic vending apparatus 100 may be connected to the user's mobile device in a wired manner. By way of example, the automatic vending apparatus 100 may be connected to the user's mobile device via the USB interface 195 to download content.

### Games

The function of providing games provides the customer with games and prizes, if any.

By way of example, the game may be supplementary performed after sale of goods, but this should not be construed as limiting. The game may be provided in various circumstances. For example, the game may be provided by the automatic vending apparatus 100 as a prize offered in a specific event.

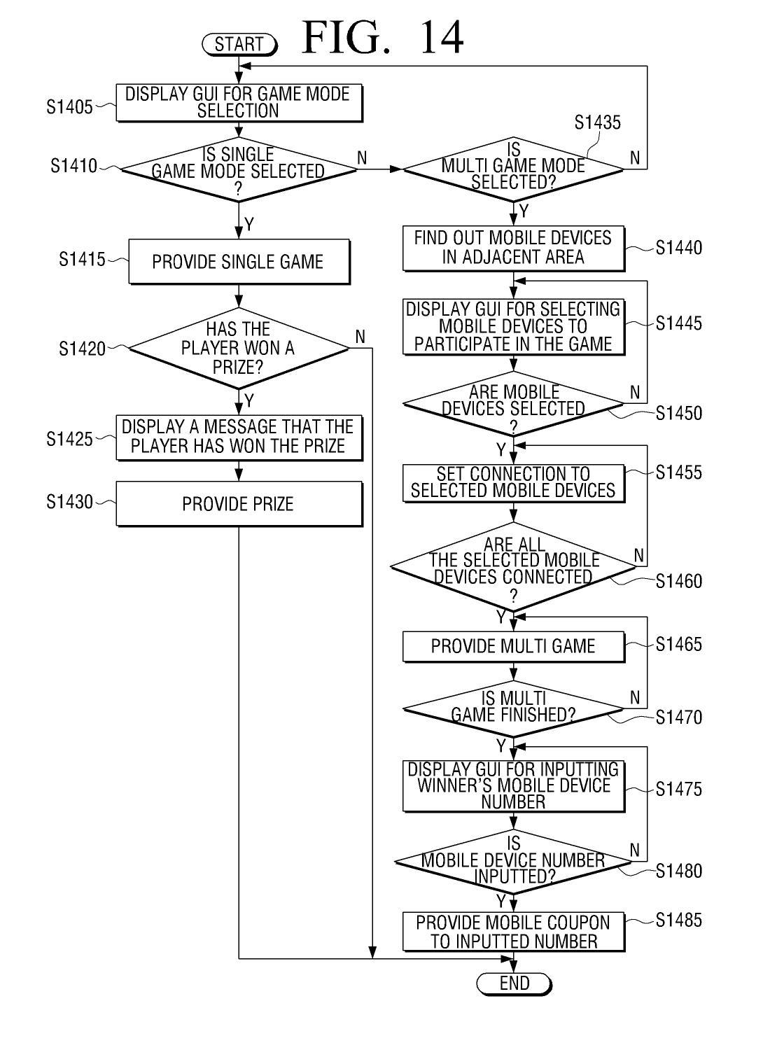

FIG. 14 is a flowchart illustrating the process of function of providing games. Referring to FIG. 14, the control unit 160 presents the customer with a GUI for game mode selection, by displaying the GUI on the touch screen, at S1405.

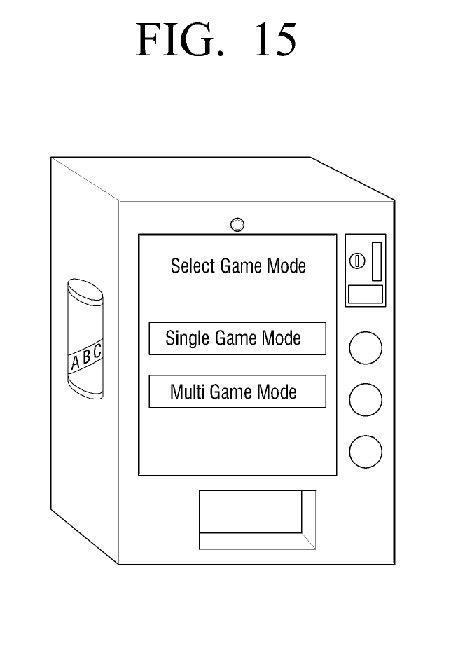

The game may include a single game mode and a multi game mode. Only one player participates in the game on the single game mode, while a plurality of players participate on the multi game mode. FIG. 15 illustrates the automatic vending apparatus 100 in which the GUI for game mode selection is displayed on the touch screen 120.

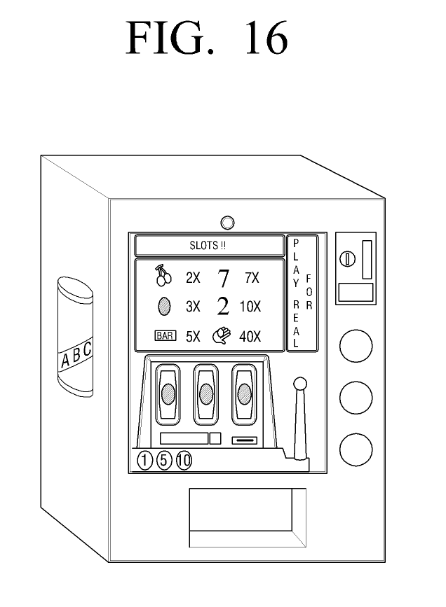

At S1410-Y, if the single game mode starts, the control unit 160 provides a single game to the customer through the touch screen at S1415. FIG. 16 illustrates the automatic vending apparatus 100 in which a slot machine game on the single game mode is provided on the touch screen 120.

By way of example, the game may offer prizes according to the result. Accordingly, if a player won a prize at the end of the single game at S1420-Y, the control unit 160 displays a message on the touch screen 120, indicating that the player has won the prize, at S1425. At S1430, the control unit 160 controls the vending unit 110 to provide one of the goods in stock through the goods release unit 113 as a prize.

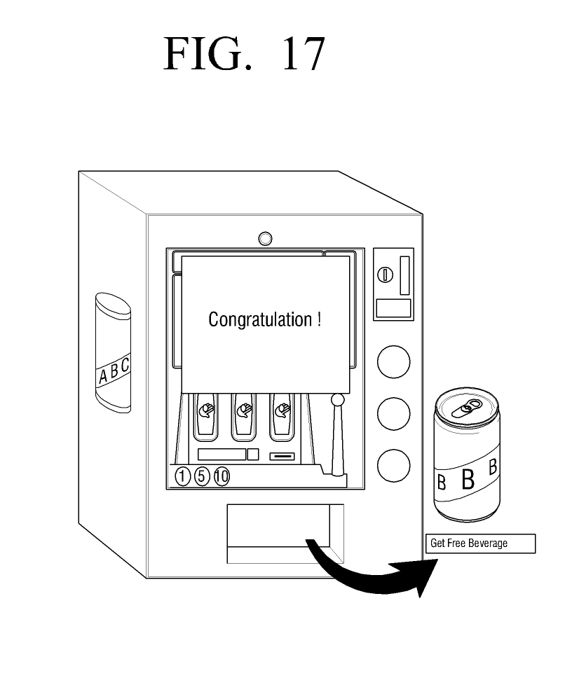

FIG. 17 illustrates the automatic vending apparatus 100 which displays the message on the touch screen 120, indicating that the player has won the prize, and subsequently provides a soft drink through the goods release unit 113 as the prize.

Meanwhile, if the customer selects the multi game mode at S1435-Y, the control unit 160 scans through the Bluetooth interface 193 to find out mobile devices located adjacent to the automatic vending apparatus 100, at S1440.

At S1445, the control unit 160 provides the customer with a GUI for mobile device selection based on the result of S1440, by displaying the GUI on the touch screen 120. The ‘GUI for mobile device selection’ lists the mobile devices found at S1440, that is, the mobile devices found out to be located adjacent to the automatic vending apparatus 100, and is constructed in a manner in which the players intending to participate in the game can select their mobile devices.

At S1450-Y, if the players select their mobile devices using the GUI, the control unit 160 controls the Bluetooth interface 193 to set a connection between the selected mobile devices of S1450, at S1455.

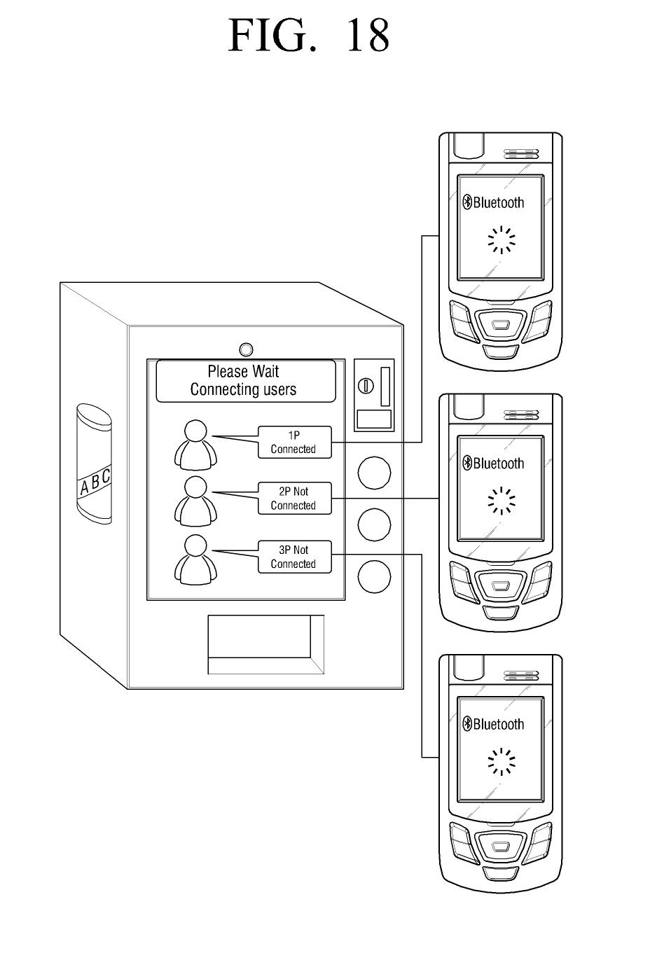

FIG. 18 illustrates the automatic vending apparatus 100 in the middle of executing S1455. Referring to FIG. 18, the touch screen 120 displays the status of connection with the participant mobile devices in the middle of S1455. In the example illustrated in FIG. 18, the first player (1P) is connected, and the second and third players (2P, 3P) are yet to be connected.

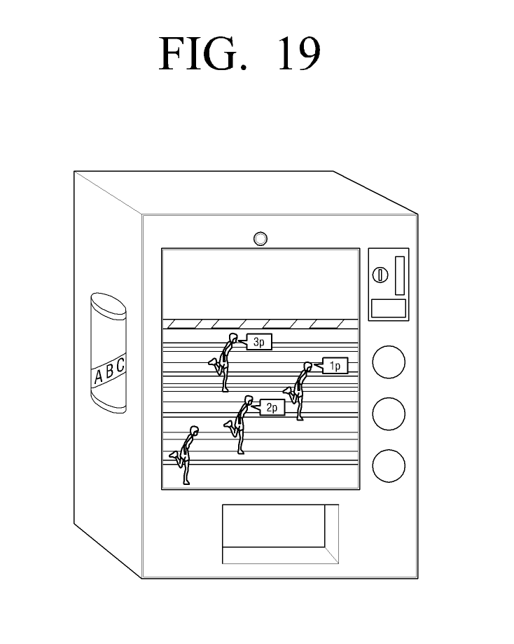

At S1460-Y, if all the selected mobile devices of S1450 are connected, the control unit 160 provides a multi game on the touch screen 120, at S1465. FIG. 19 illustrates the automatic vending apparatus 100 in which a multi game is provided on the touch screen 120.

As a result, the players participate in the multi game using their mobile devices. In the multi game, the mobile devices may operate as a game controller such as joystick.

According to an example of the present invention, the multi game may offer a prize to the winner, and the prize may be provided in the form of a mobile coupon.

To this end, if the multi game is finished at S1470-Y, the control unit 160 displays a GUI for inputting device number on the touch screen 120, at S1475.

Accordingly, at S1480-Y, if the winner inputs his mobile device number through the GUI of S1475, the control unit 160 issues a mobile coupon to the number inputted at S1480, at S1485.

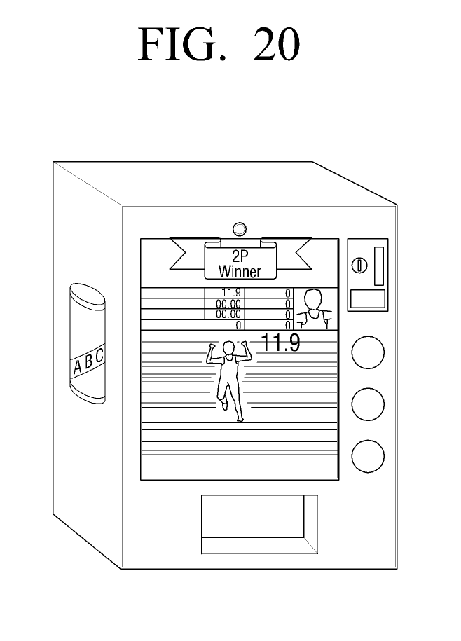

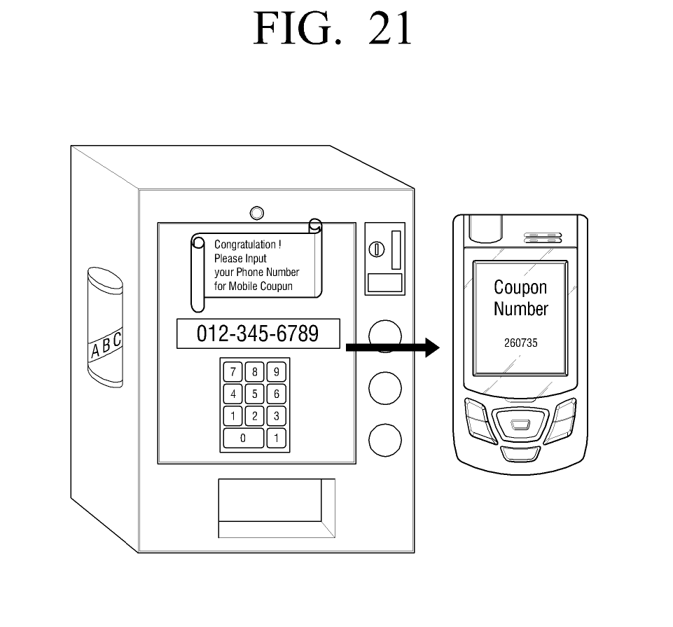

FIG. 20 illustrates an example in which the second player (2P) wins the multi game. FIG. 21 illustrates the winner inputting his mobile device number using the GUI for inputting device number, and a mobile coupon received at the winner's mobile device as a result.

The winner may receive goods from the automatic vending apparatus 100 using the mobile coupon received at his mobile device.

### Protection

The function of providing protection includes notifying a manager at a distance as well as people around the automatic vending apparatus 100 when the automatic vending apparatus is under threat of destruction.

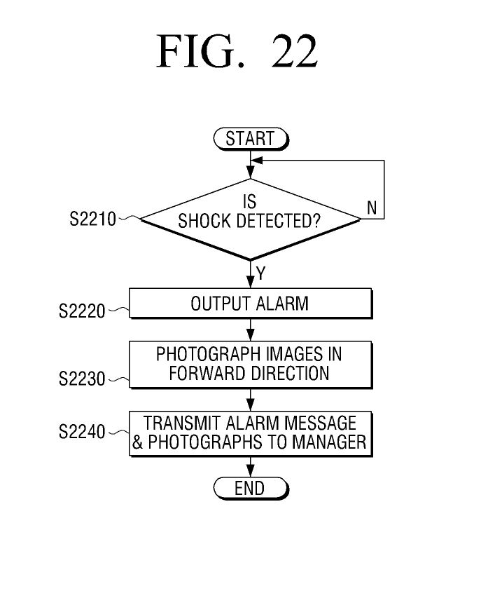

FIG. 22 is a flowchart illustrating the process of protection function. Referring to FIG. 22, if the shock sensor 183 detects that the automatic vending apparatus 100 is struck at S2210-Y, the control unit 160 outputs an alarm message through the touch screen 120 and the speaker 130 at S2220. By the operation at S2220, the automatic vending apparatus 100 indicates to the people therearound that someone is trying to damage the automatic vending apparatus 100.

In the middle of operation at S2220, the control unit 160 controls the photographing unit 150 to photograph the object in front of the automatic vending apparatus 100, at S2230. Next, at S2240, the control unit 160 transmits to a manager a message to notify that the automatic vending apparatus 100 is being damaged, along with the photographs captured through the photographing unit 150.

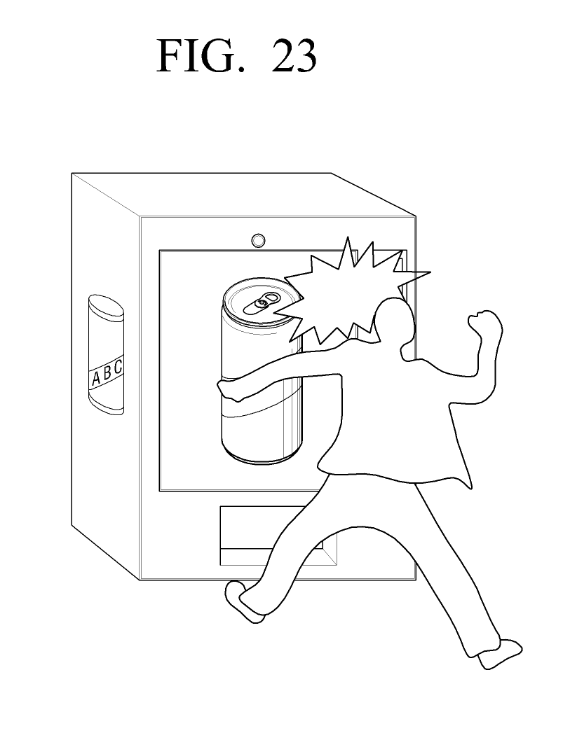

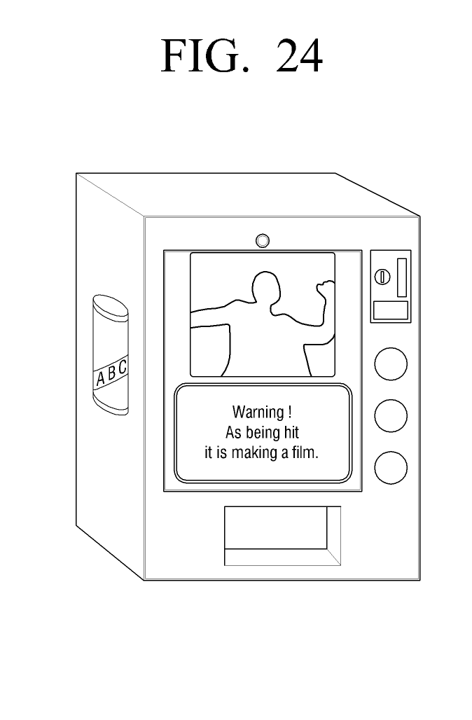

FIG. 23 illustrates someone striking the automatic vending apparatus 100, and FIG. 24 illustrates the photograph taken at S2230 and explanation of current status appearing on the touch screen 120.

The same photograph and explanation appearing on the touch screen 120 illustrated in FIG. 24 are transmitted to the manager at a distance via the network interface.

### Notices

The function of providing notices includes notifying a manager at a distance if the automatic vending apparatus 100 malfunctions or likely to malfunction.

To this end, the control unit 160 notifies the manager at a distance via the network interface 191, upon determining that the automatic vending apparatus 100 has a problem in its hardware (H/W) or software (S/W), or is likely to have the problem.

By way of example, the automatic vending apparatus 100 may have a problem in the hardware (H/W) if the temperature of the automatic vending apparatus 100 exceeds a threshold temperature. Accordingly, upon determining that the temperature sensed through the temperature sensor 185 exceeds a threshold temperature, the control unit 160 may transmit to the manager at a distance a message to indicate that the automatic vending apparatus 100 is likely to be out of order due to overheating, via the network interface 191.

Meanwhile, the function of providing notices may also be used in the examples other than notifying malfunction or possibility of malfunction of the automatic vending apparatus 100. By way of example, the automatic vending apparatus 100 may also notify the manager at the distance if goods are going to be out of stock.

### Advertisement

The function of providing advertisement may include providing product advertisement on the touch screen 120 of the automatic vending apparatus 100. The advertisement may or may not relate to the goods on sale by the automatic vending apparatus 100.

Prior to explaining the function of providing advertisement, it is necessary to understand the servers in the same network as the automatic vending apparatus 100. Accordingly, a network structure of the automatic vending apparatus 100 and the servers will first be explained below.

### Network Structure

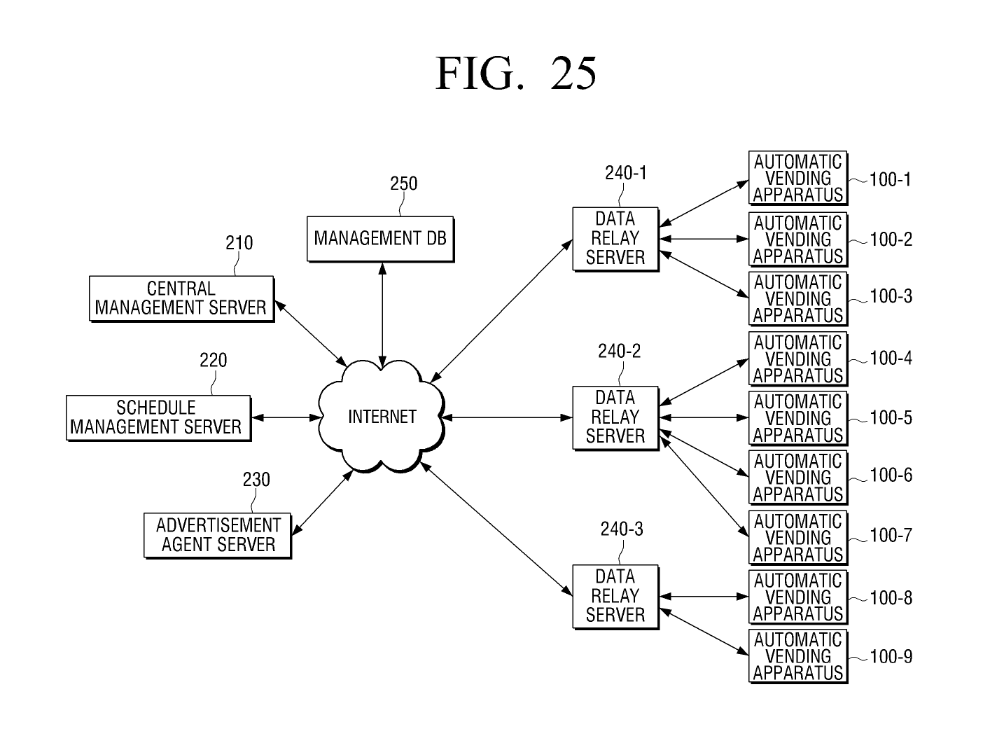

FIG. 25 illustrates a network applicable according to an exemplary embodiment of the present invention. Referring to FIG. 25, the network may include a central management server 210, a schedule management server 220, an advertisement agent server 230, data relay servers 240-1, 240-2, 240-3, a management database (DB) 250, and automatic vending apparatuses 100-1 to 100-9.

The central management server 210 has advertisement contents, and operates to distribute the advertisement contents and advertisement schedule timetable to the data relay servers 240-1, 240-2, 240-3.

The schedule management server 220 makes/updates an advertisement schedule timetable, and provides the updated information to the central management server 210.

The advertisement agent server 230 may be used by an advertising agency. The advertising agency makes a request on behalf of its clients so that the advertisement contents requested by the clients are replayed through the automatic vending apparatuses 100-1 to 100-9.

The data relay servers 240-1, 240-2, 240-3 re-distribute the advertisement contents and the advertisement schedule timetable received from the central management server 210 to the automatic vending apparatuses 100-1 to 100-9.

The management DB 250 stores information necessary for a manager to manage the automatic vending apparatuses 100-1 to 100-9 and marketing. The information necessary to manage marketing may include goods sales, customer surveys, or the like, which will be explained in greater detail below.

Although FIG. 25 illustrates the servers communicatably connected via the internet, the servers may be connected by other means of network such as local area network (LAN), metro area network (MAN), wide area network (WAN), or the like.

Furthermore, although FIG. 25 illustrates that the central management server 210 and the schedule management server 220 are separately provided to increase efficiency, considering that the central management server 210 needs to transmit and receive a large volume of advertisement content, and the schedule management server 220 needs to manage advertisement schedule timetable in real time and fast and without an error, this should not be construed as limiting, and other examples are possible. For example, one single server integrating the central management server 210 and the schedule management server 220, may be employed as necessary.

Likewise, the data relay servers 240-1, 240-2, 240-3 may be omitted, and the central management server 210 may additionally have the function of the data relay servers 240-1, 240-2, 240-3.

The structure of the network has been explained above, and the process of providing advertisement under the abovementioned network structure will be explained in greater detail below.

### Advertisement on Schedule

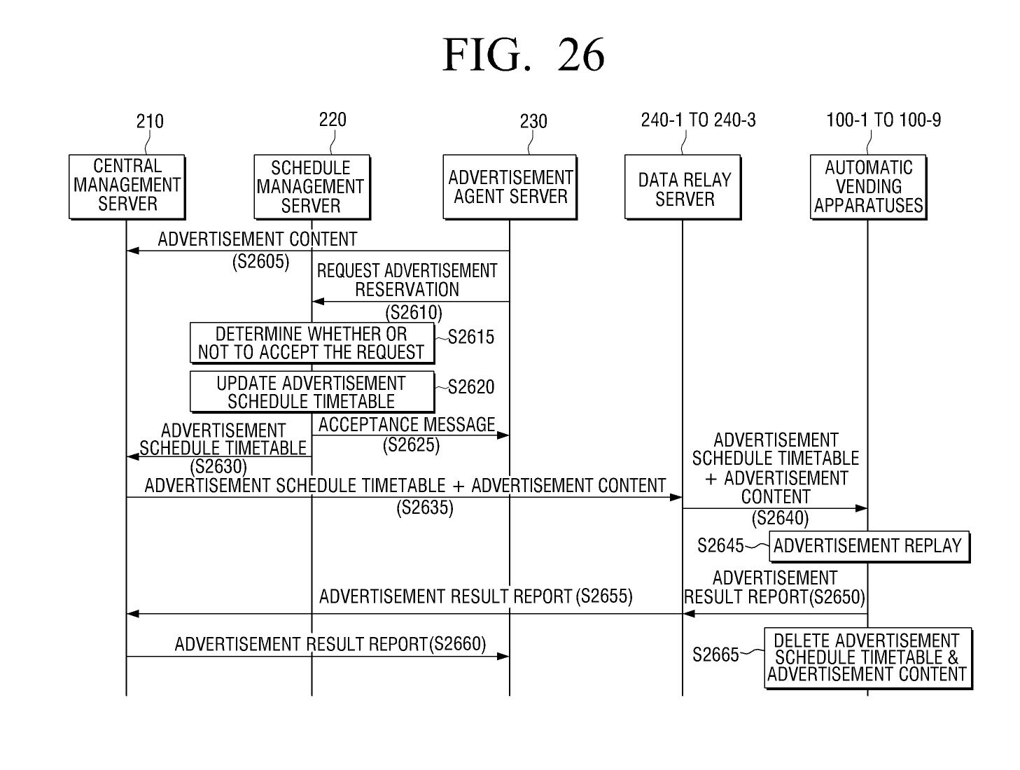

FIG. 26 illustrates a series of operations taken to provide a reserved advertisement according to schedule.

In order to provide the reserved advertisement according to schedule, referring to FIG. 26, the advertisement agent server 230 uploads the advertisement content to the central management server 210, at S2605.

The advertisement content uploaded from the advertisement agent server 230 to the central management server 210 corresponds to the advertisement that the client requests the advertising agency to distribute or create/distribute.

At S2610, the advertisement agent server 230 transmits an advertisement reservation request message (‘reservation request’) to the schedule management server 220. The reservation request may include place or date of advertisement, advertisement content, method of advertisement, or the like, as desired by the client.

The schedule management server 220 in receipt of the reservation request of S2610 determines whether or not to accept the reservation request, in accordance with the details written in the reservation request, at S2615.

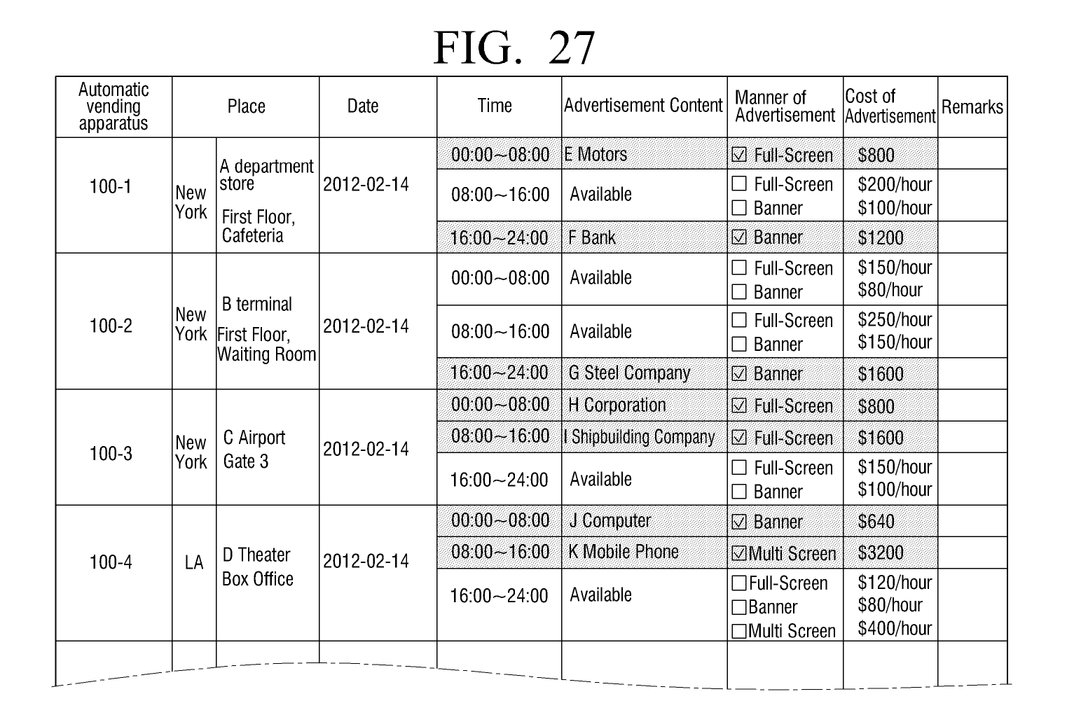

The schedule management server 220 may refer to the advertisement schedule timetable to determine whether or not to accept the reservation request at S2615. FIG. 27 illustrates an example of the advertisement schedule timetable, which will be explained after the explanation with respect to FIG. 26.

If the schedule management server 220 accepts the reservation request, the schedule management server 220 updates the advertisement schedule timetable by reflecting the acceptance, at S2620.

Next, the schedule management server 220 notifies that the reservation request of S2610 is accepted, by transmitting a reservation acceptance message to the advertisement agent server 230, at S2625.

Meanwhile, the schedule management server 220 transmits the advertisement schedule timetable updated at S2620 to the central management server 210, at S2630.

The central management server 210 in receipt of the advertisement schedule timetable of S2630 transmits the received advertisement schedule timetable and the advertisement content to the data relay servers 240-1 to 240-3, at S2635. Accordingly, the data relay servers 240-1 to 240-3 relay the advertisement schedule timetable and the advertisement content received at S2635 to the automatic vending apparatuses 100-1 to 100-9, at S2640.

At S2640, the data relay servers 240-1 to 240-3 transmit the advertisement schedule timetable and the advertisement content only to the automatic vending apparatuses 100-1 to 100-9 which are connected thereto directly. Accordingly, in the case of the network structure illustrated in FIG. 25, the first data relay server 240-1 transmits the advertisement schedule timetable and the advertisement content to the first to third automatic vending apparatuses 100-1 to 100-3, the second data relay server 240-2 transmits to the fourth to seventh automatic vending apparatuses 100-4 to 100-7, and the third data relay server 240-3 transmits to the eighth and ninth automatic vending apparatuses 100-8, 100-9, respectively.

At S2640, the advertisement schedule timetable and the advertisement content are stored in the storage units 170 which are provided at the automatic vending apparatuses 100-1 to 100-9. The automatic vending apparatuses 100-1 to 100-9 replay the advertisement content stored in the storage unit 170 through the touch screen 120 and the speaker 140 according to the advertisement schedule, at S2645.

After that, the automatic vending apparatuses 100-1 to 100-9 transmit the report on the advertising result of S2645 to the data relay servers 240-1 to 240-3, at S2650. Accordingly, the data relay servers 240-1 to 240-3 gather the reports of S2650 and transmit the reports to the central management server 210, at S2655.

By way of example, at S2655, the first data relay server 240-1 may gather the reports received from the first to third automatic vending apparatuses 100-1 to 100-3, the second data relay server 240-2 may gather the reports received from the fourth to seventh automatic vending apparatuses 100-4 to 100-7, and the third data relay server 240-3 may gather the reports received from the eighth and ninth automatic vending apparatuses 100-8, 100-9, and then transmit the gathered reports to the central management server 210.

Next, the central management server 210 transmits the reports received at S2655 to the advertisement agent server 230, at S2660. At S2660, the central management server 210 may gather and transmit only the necessary reports to the advertisement agent server 230. The ‘necessary reports’ refer to the advertisement result reports regarding the advertisements requested to be reserved by the advertisement agent server 230.

After completion of the operation at S2650, the control units 160 of the automatic vending apparatuses 100-1 to 100-9 delete the advertisement schedule timetable and the advertisement content from the storage unit 170, at S2665, since the advertisement schedule timetable and the advertisement content are not necessary any more once the operation at S2650 is completed. By doing so, it is possible to ensure a space of the storage unit 170 to store new advertisement schedule timetable and advertisement content which will be received afterward.

The process of providing reserved advertisement according to schedule has been explained so far. Hereinbelow, the advertisement schedule timetable will be explained in detail with reference to FIG. 27, and then the manner of using the advertisement schedule timetable in the processes described above, will be explained.

### Advertisement Schedule Timetable

FIG. 27 illustrates an example of the advertisement schedule timetable. Referring to FIG. 27, the advertisement schedule timetable lists general items related to the advertisement, which may include the place, date, content, manner, or cost of advertisement categorized for each of the automatic vending apparatuses 100-1 to 100-9 (only for 100-1 to 100-4 shown).

In the advertisement schedule timetable illustrated in FIG. 27, the darker time zone, i.e., darker time slot, represents the time zone which includes the accepted advertisement request, while the bright time zone represents the time zone which does not include the accepted advertisement request.

According to the advertisement schedule timetable illustrated in FIG. 27, the first automatic vending apparatus 100-1 is installed in ‘cafeteria, first floor, A department store, New York’ and reserved to advertise ‘E Motors’ at ‘2012-02-14, 00:00-08:00’, in the ‘full screen’ manner for the payment of ‘$800’, and reserved to advertise ‘F Bank’ at ‘2012-02-14, 16:00-24:00’ in the ‘banner’ manner, for the payment of ‘$1200’.

Meanwhile, the mark ‘available’ for the advertisement content in the time zone of ‘2012-02-14, 08:00-16:00’ of the first automatic vending apparatus 100-1, represents that no advertisement is reserved for the duration of ‘2012-02-14, 08:00-16:00’ and that this time zone is open for reservation. The mark ‘full screen’ or ‘banner’ in the advertisement manner represents the manner of advertisement available by the first automatic vending apparatus 100-1, and the ‘advertisement cost’ indicates the cost per predetermined time unit for each of the advertisement manners.

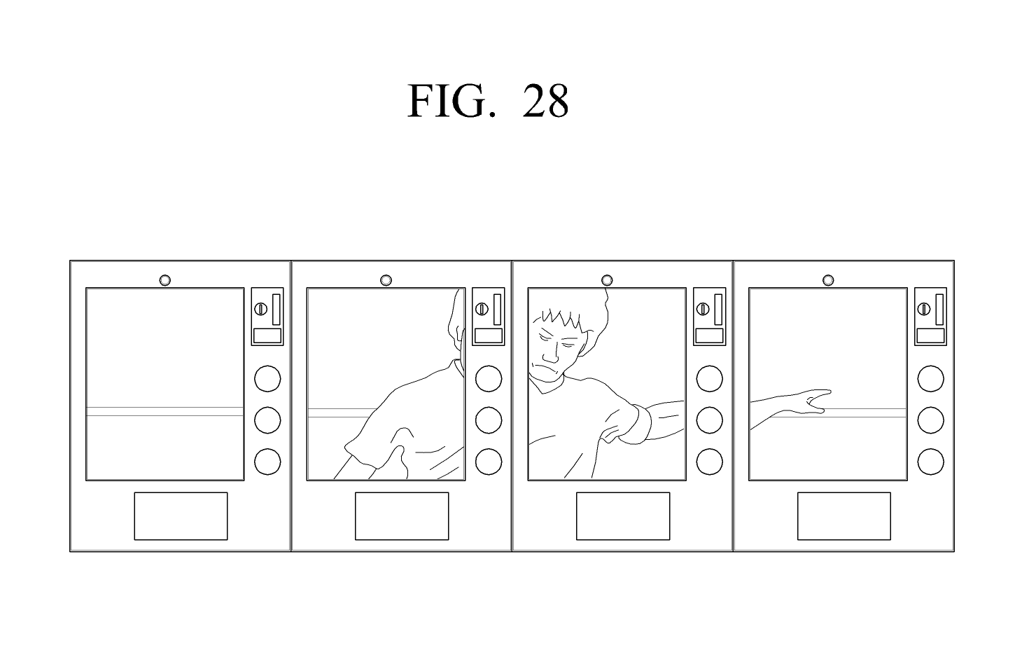

Meanwhile, ‘multi screen’ is indicated as the advertisement manner, in the time zone of ‘2012-02-14 08:00-16:00’ and ‘2012-02-14 16:00-24:00’ of the fourth automatic vending apparatus 100-4. The ‘multi screen’ refers to providing one advertisement through a plurality of automatic vending apparatuses. Accordingly, it is necessary that a plurality of automatic vending apparatuses are installed in the same place. FIG. 28 illustrates a plurality of automatic vending apparatuses performing ‘multi screen’ advertisement.

Hereinbelow, the manner of using the advertisement schedule timetable in the operations of FIG. 26 will be explained.

First, the advertisement schedule timetable may be used as a reference when the place, date, content, and manner of advertisement are selected to be written in the advertisement reservation request message (‘request message’) before the request message is transmitted at S2610. To this end, the advertisement agent server 230 receives the advertisement schedule timetable from the schedule management server 220 in real time or periodically, and provides the advertisement schedule timetable upon request by the client or the advertising agent.

As explained above, the advertisement schedule timetable indicates information about time and place which are open for reservation, and even provides available advertisement manner and cost. Accordingly, the client or the advertising agent can make the reservation request conveniently using the advertisement schedule timetable.

Second, as mentioned above, the advertisement schedule timetable may be used by the schedule management server 220 as a reference in determining whether or not to accept the advertisement reservation request, because the advertisement schedule timetable provides the status of reservation.

The schedule management server 220 determines whether there is a reservation made and accepted at a desired time and place based on the advertisement schedule timetable, and determines whether or not to accept the reservation request accordingly.

Accordingly, the reservation request will not be accepted at the time and place where there is another already accepted reservation, but the requesting party can anticipate that the reservation request will be accepted at the time and place which have no reservation previously accepted.

Third, the advertisement schedule timetable may be used by the automatic vending apparatuses 100-1 to 100-9 to replay advertisement content at S2645, because the advertisement content must be replayed on schedule at S2645.

Additionally, the advertisement schedule timetable may be updated at S2620, transmitted among devices at S2630, S2635, S2640, or deleted at S2665.

Herein, the advertisement schedule timetable may not be entirely transmitted among the devices at S2630, S2635, S2640. By way of example, in the case where the central management server 210 transmits the advertisement schedule timetable to the first data relay server 240-1 at S2635, the central management server 210 may transmit the advertisement schedule timetable regarding the first, second and third automatic vending apparatuses 100-1, 100-2, 100-3 of FIG. 27 only.

Likewise, if the first data relay server 240-1 transmits the advertisement schedule timetable to the first automatic vending apparatus 100-1 at S2640, the advertisement schedule timetable regarding only the first automatic vending apparatus 100-1 of FIG. 27 may be transmitted.

Although it is described above that the advertisement schedule timetable and the advertisement content are transmitted in the route of: central management server 210->data relay servers 240-1 to 240-3->automatic vending apparatuses 100-1 to 100-9, this should not be construed as limiting and other examples are possible. For example, the advertisement schedule timetable and the advertisement content may be provided to the automatic vending apparatuses 100-1 to 100-9 directly, if there is the problem in the existing transmission route or if it is necessary.

Additionally, a USB device, storing therein the advertisement schedule timetable and the advertisement content, may be connected to the USB interface 195 of the automatic vending apparatuses 100-1 to 100-9, so that the advertisement schedule timetable and the advertisement content are downloaded from the USB device to the storage units 170 of the automatic vending apparatuses 100-1 to 100-9.

Meanwhile, the advertisement schedule timetable may be embodied to additionally provide detailed information regarding the place of advertisement. By doing so, the client or advertising agent may have more detailed information before he makes a request.

By way of example, the detailed information regarding the place of advertisement may include floating population, time of traffic, or photographs of the place.

The ‘floating population’ may be categorized by gender, age, or gender and age. The ‘time of traffic’ refers to time when the population passes the place.

By way of example, if the place is the department store, the time of traffic may correspond to the duration of time that the department store is open. If the place is the subway station, then the time of traffic may correspond to the subway operating time.

Meanwhile, although it has been described above that the advertisement schedule timetable is set on the daily basis, this should not be construed as limiting and other examples are possible. By way of example, the advertisement schedule timetable may be set on a weekly or monthly basis.

Furthermore, the automatic vending apparatuses 100-1 to 100-9 may also be embodied to replay UCC, in addition to the advertisement content.

### Automatic Vending & Advertisement

The process and method of providing advertisement on the automatic vending apparatus 100 have been explained above. Meanwhile, it is also possible that the automatic vending apparatus 100 provides the advertisement in association with the automatic vending.

By way of example, an advertisement may be provided to the customer who has already made a purchase (see S350, FIG. 3), regarding another goods which is related to, or goes well with the purchased goods.

Specifically, advertisement of certain type of snack may be provided to a customer who is waiting for a soft drink he has just purchased, on the touch screen 120 of the automatic vending apparatus 100. Preferably, the snack kept in stock in the automatic vending apparatus 100 may be advertised, so that the customer can immediately purchase the advertised goods and the automatic vending apparatus 100 can have increased sales.

### Information

The function of providing information includes providing useful information on the touch screen 120 of the automatic vending apparatus 100. The ‘useful information’ may include a variety of information such as really simple syndication (RSS), broadcast, emergency notice which will be explained below, and others.

### RSS

The automatic vending apparatus 100 may be connected to the internet via the network interface 191. Accordingly, the automatic vending apparatus 100 can receive RSS via the internet and provides the received RSS on the touch screen 120.

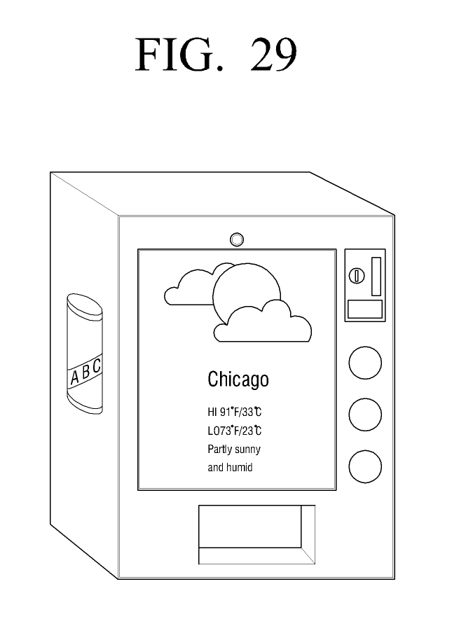

There is no limit for the type of RSS that the automatic vending apparatus 100 can receive from the internet via the network interface 191 and provide on the touch screen. FIG. 29 illustrates the automatic vending apparatus 100 providing RSS of the local weather on the touch screen 120.

### Broadcast

The automatic vending apparatus 100 may also receive a broadcast from the internet via the network interface 191. In this case, the automatic vending apparatus 100 may receive a broadcast from the internet and provide the received broadcast on the touch screen 120.

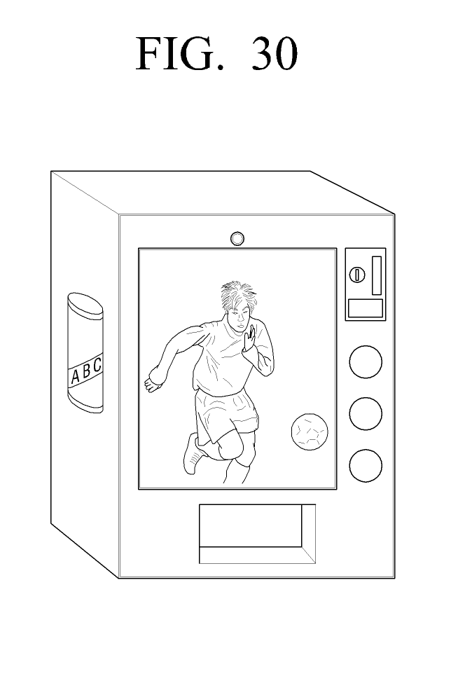

FIG. 30 illustrates the automatic vending apparatus 100 providing a sports broadcast on the touch screen 120.

### Emergency Notice

The automatic vending apparatus 100 may also provide other types of useful information on the touch screen 120, by receiving the information from the network such as the internet, or LAN through the network interface 191. By way of example, the ‘useful information’ may include breaking news, missing children information, or the like.

For better effect of the advertisement, the automatic vending apparatus 100 providing the missing child information on the touch screen 120 may preferably be the one 100 that is located at or near the place where the child was lost.

### Marketing Management

### Sales Management

The control unit 160 provided in the automatic vending apparatus 100 totals the amount of sales made by the vending unit 110 and stores the result in the storage unit 170. The totals may be categorized by goods or time zone.

The result of totaling may be used as a reference when the control unit 160 generates and provides a GUI for sales of goods on the touch screen 120. By way of example, based on the amount of sales categorized by goods, the control unit 160 may display the goods of relatively higher sales on the place of the GUI such as upper portion or left side that attracts the customer's attention more than others.

Likewise, based on the amount of sales categorized by time zone, the control unit 160 may display the goods of higher sales in the current time zone on the place of the GUI that attracts the customer's attention more than others. By way of example, coffee has the higher sales in the morning, and thus may preferably be arranged on the best place of the GUI in the morning, while soft drinks having the higher sales in the afternoon may preferably be arranged on the best place of the GUI in the afternoon.

Meanwhile, the control unit 160 may transmit the result of totaling stored in the storage unit 170 to the manager through the network interface 191 so that the manager utilizes the result in his marketing activity.

### Customer Survey

The customer survey is gathering of information regarding customers of the automatic vending apparatus 100, such as gender, or age of the customers.

In order to perform the customer survey, the automatic vending apparatus 100 needs to receive an ID of the customer. The automatic vending apparatus 100 then matches the purchased goods with the ID of the customer who purchased the goods, and stores the information in the form of table at the storage unit 160. The automatic vending apparatus 100 transmits the stored table to the manager through the network interface 191 so that the manager can utilize the table in his marketing activity.

Meanwhile, the automatic vending apparatus 100 may need to have means to which the customer can input his ID. By way of example, the automatic vending apparatus 100 may include a card reader to read in an ID of a customer's from his membership card, or a radio frequency identification (RFID) reader to read an ID of the customer from the RFID tag.

### Others

The control unit 160 may record the history of the automatic vending apparatus 100 in the storage unit 170. The history of the automatic vending apparatus 100 may include operating time, record of malfunction, or the like.

Referring to FIG. 25, the automatic vending apparatuses 100-1 to 100-9 are connected with each other in a network. Accordingly, all of the automatic vending apparatus 100-1 to 100-9 may have price update at the same time.

Furthermore, it is also possible to command all the automatic vending apparatuses 100-1 to 100-9 to stop vending operation altogether, if the goods on sale has problem.

As explained above, according to exemplary embodiments of the present invention, it is possible to provide advertisement through the automatic vending apparatuses 100-1 to 100-9 according to a predetermined schedule timetable. Therefore, advertisement can be provided in more systematic, various and efficient manners. Furthermore, the automatic vending apparatuses 100-1 to 100-9 according to exemplary embodiments of the present invention can be used for various different purposes, in addition to the automatic vending operation.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An automatic vending apparatus, comprising:
a touch screen which displays a graphic user interface (GUI) for a sale of a good;
a vending unit which provides the good if the good is ordered through the GUI for the sale of the good and a payment for the ordered good is received;
a communication interface which receives advertisement content and a schedule through a network;
a storage unit which stores the received advertisement content and the schedule; and
a control unit which replays in a replay, the stored advertisement content on the touch screen in accordance with the stored schedule.

2. The automatic vending apparatus of claim 1, wherein the control unit deletes at least one of the stored schedule and the stored advertisement content from the storage unit, if the replay of the stored advertisement content according to the schedule, is finished.

3. The automatic vending apparatus of claim 1, wherein the control unit replays advertisement content about another good related to the ordered good, on the touch screen, during a time when the automatic vending unit provides the ordered good.

4. The automatic vending apparatus of claim 1, wherein the schedule comprises at least one of place, date, content, manner, and cost of advertisement.

5. The automatic vending apparatus of claim 1, wherein the storage unit additionally stores content, and the control unit downloads the stored content of the storage unit to a user's device through the communication interface.

6. The automatic vending apparatus of claim 5, wherein the control unit deletes the content from the storage unit if a predetermined period elapses.

7. The automatic vending apparatus of claim 1, further comprising a photographing unit which photographs an image in front of the automatic vending apparatus, and the control unit transmits the image photographed by the photographing unit to a path designated by a user through the communication interface.

8. The automatic vending apparatus of claim 1, wherein the control unit controls so that a game is provided on the touch screen and the good is provided free-of-charge through the vending unit according to a result of the game.

9. The automatic vending apparatus of claim 1, wherein the control unit notifies a manager through the communication interface if the automatic vending apparatus has at least one of destruction, malfunction, and problem about stock.

10. The automatic vending apparatus of claim 1, wherein the control unit displays information received through the communication interface on the touch screen, in which the information comprises a really simple syndicate (RSS), a broadcast, and an emergency notice.

11. The automatic vending apparatus of claim 1, wherein the control unit stores information about sales amount, and customers to the storage unit, and notifies the stored information to the manager through the communication interface.

12. A method for providing an advertisement in an automatic vending apparatus which provides a good if the good is ordered and paid, the method comprising:
receiving advertisement content and a schedule through a network;
storing the received advertisement content and the schedule; and
replaying the stored advertisement content in accordance with the stored schedule.

13. The method of claim 12, further comprising deleting the schedule and the advertisement content from the storage unit, if the replaying of the stored advertisement content according to the schedule is finished.

14. The method of claim 12, further comprising replaying advertisement content about another good related to the ordered good, during a time when the ordered good is being provided.

15. The method of claim 12, wherein the schedule comprises at least one of place, date, content, manner, and cost of advertisement.

16. A method of scheduling advertisement on a plurality of automatic vending machines, the method comprising:
displaying an advertisement schedule timetable showing a first advertisement schedule of a first automatic vending apparatus and a second advertisement schedule of a second automatic vending apparatus, the first advertisement schedule indicating unreserved time slots and reserved time slots of the first automatic vending machine and the second advertisement schedule indicating unreserved time slots and reserved time slots of the second automatic vending machine; and
selecting at least one of the unreserved time slots of the first and the second automatic vending machines to reserve the at least one of the unreserved time slots for the corresponding one of the first and the second automatic vending machine to display an advertisement.

17. The method of claim 16, wherein the advertisement schedule timetable shows a manner of presenting the advertisement and a corresponding cost of advertisement.

18. The method of claim 17, wherein the manner of presenting the advertisement is one of displaying the advertisement in a full-screen manner or a banner.
